(19) United States
(12) Patent Application Publication
(10) Pub. No.: US 2024/0162552 A1
(43) Pub. Date: May 16, 2024

(54) BATTERY CASING BOTTOM STRUCTURE

(71) Applicant: TOYOTA JIDOSHA KABUSHIKI KAISHA, Aichi-ken (JP)

(72) Inventor: Mutsumi KAWASHIMA, Nisshin-shi (JP)

(21) Appl. No.: 18/507,094

(22) Filed: Nov. 13, 2023

(30) Foreign Application Priority Data
Nov. 14, 2022 (JP) 2022-181743

(51) Int. Cl. H01M 50/262; B60R 16/04; H01M 50/249

(52) U.S. Cl. CPC H01M 50/262; B60R 16/04; H01M 50/249; H01M 2220/20

(57) ABSTRACT

A battery casing bottom structure is mounted in a lower part of a vehicle and includes a combination of extruded members. The bottom structure includes a first extruded member including a notch that is a cut portion at an end in an extrusion direction on a top face of the first extruded member, and a second extruded member having a hollow shape and including a rib connecting a top face portion and an undersurface portion. The first extruded member and the second extruded member are joined to each other by covering the notch of the first extruded member with an undersurface of the second extruded member from above. The extrusion direction of the first extruded member and an extrusion direction of the second extruded member are perpendicular to each other. The rib is positioned immediately above a portion where the first extruded member and the second extruded member are joined.

### CROSS REFERENCE TO RELATED APPLICATION

This application claims priority to Japanese Patent Application No. 2022-181743 filed on Nov. 14, 2022, which is incorporated herein by reference in its entirety including the specification, claims, drawings, and abstract.

### TECHNICAL FIELD

The present disclosure relates to a bottom structure of a battery casing mounted on a vehicle.

### BACKGROUND

Battery casings having various structures have been proposed for protecting a battery disposed in a lower part of an electric motor vehicle such as a battery electric vehicle (BEV) or a plug-in hybrid electric vehicle (PHEV).

JP 2020-183222 A discloses a battery module protection structure including a casing storing a battery module and a guard member disposed below the casing and having a hollow sectional shape, with a gap having a predetermined clearance between the casing and the guard member. The protection member having such a configuration has an enhanced protection effect against an external input load.

During traveling of a vehicle, substances on the road surface or pebbles or gravels may interfere, from below, with the battery disposed under the vehicle and may damage the battery. Effective structures of the battery casing for protecting the battery therefore need to be considered. To increase rigidity, for example, the battery casing may employ a bottom structure including a combination of extruded aluminum members. This structure including a combination of two extruded members having different extrusion directions may further increase rigidity; however, joining the two extruded members may cause a deficiency. Specifically, in fit-joining or butt-joining of the two extruded members, the joined portion or joint would protrude downward.

In consideration of aerodynamics or interferential input from the road, an effective battery casing has a bottom structure having a flat or substantially horizontally planar undersurface. The above structure, however, has a joint that protrudes downward and therefore cannot have a flat undersurface. This structure would receive, by the protruding portion, a load of an interferential input from under the vehicle; however, the bottom part of the battery casing has insufficient rigidity and cannot protect the battery properly. FIGS. 4 and 5 illustrate example battery casing bottom structures having such a deficiency.

FIG. 4 is a cross sectional view of a battery casing bottom part having a different structure from a bottom structure of a battery casing disclosed in the present specification. More specifically, FIG. 4 is a cross sectional view of a battery casing bottom part 10 including two fit-joined extruded members 12 and 14 having different extrusion directions. In the following description, the extruded member 12 will be referred to as a first extruded member 12, and the extruded member 14 will be referred to as a second extruded member 14. In the drawings, identical elements are denoted with identical reference numerals. As illustrated in FIG. 4, the first extruded member 12 and the second extruded member 14 are joined together with arc welding at two locations encircled with broken lines. In joining, a recess portion of the second extruded member 14 disposed under a side face of the second extruded member 14; more specifically, a side face of the second extruded member 14 to be joined with the first extruded member 12, fits to catch an end portion of the first extruded member 12, as illustrated in FIG. 4. In this configuration, an undersurface 14a of the second extruded member 14 corresponds to the lowermost face of the bottom part 10 of the battery casing. As such, the lowermost face of the bottom part 10 of the battery casing is the undersurface 14a that is a specific narrow region, not a wide region. The battery casing bottom structure illustrated in FIG. 4 therefore cannot achieve a structure with a flat undersurface.

FIG. 5 is a cross sectional view of a battery casing bottom part having a different configuration from the battery casing bottom structure disclosed in the present specification. More specifically, FIG. 5 is a cross sectional view of a battery casing bottom part 10 including butted-joined first and second extruded members 12 and 14 having different extrusion directions. Butted joining of the first extruded member 12 and the second extruded member 14 with high frequency welding, for example, creates a welding trace to raise and thereby form a welding bead 16. As illustrated in FIG. 5, the welding bead 16 protrudes further downward from the respective undersurfaces of the first extruded member 12 and the second extruded member 14. Therefore, the battery casing bottom part 10 illustrated in FIG. 5, similar to the battery casing bottom part 10 in FIG. 4, cannot achieve a structure with a flat undersurface.

The present specification therefore discloses a battery casing bottom structure including a combination of two extruded members having different extrusion directions for enhanced rigidity and also including a substantially horizontally planar undersurface.

### SUMMARY

A battery casing bottom structure disclosed in the present specification includes a combination of extruded members and is mounted in a lower part of a vehicle. The battery casing bottom structure includes a first extruded member including a notch that is a cut portion at an end in an extrusion direction of the first extruded member on a top face of the first extruded member, and a second extruded member having a hollow shape and including a rib connecting a top face portion and an undersurface portion. The first extruded member and the second extruded member are joined to each other by covering the notch of the first extruded member with an undersurface of the second extruded member from above. The extrusion direction of the first extruded member and an extrusion direction of the second extruded member are perpendicular to each other. The rib is positioned immediately above a portion where the first extruded member and the second extruded member are joined.

The second extruded member is joined to the first extruded member by covering the notch of the first extruded member with the second extruded member from above. This configuration allows the second extruded member to be placed on the first extruded member, and therefore allows the undersurface of first extruded member to serve as the lowermost face of the battery casing bottom part, which has a substantially horizontally planar shape in a wide region. This configuration further includes the rib immediately above the joined portion of the first extruded member and the second extruded member to thereby increase rigidity of the battery casing bottom part.

In the above battery casing bottom structure, the undersurface of the second extruded member includes a first portion joined with the notch and a second portion located at a lower level than the first portion in a vertical direction, to thereby provide a seat surface shape, and the second portion that is a lowermost face of the second extruded member and an undersurface of the first extruded member are disposed to provide a substantially horizontally planar shape.

This configuration including the undersurface of the second extruded member having a seat surface shape can more effectively increase rigidity of the battery casing bottom part. This configuration further allows the lowermost face of the second extruded member and the undersurface of the first extruded member to be at the same ground level, to thereby provide the lowermost face of the battery casing bottom part having a substantially horizontally planar shape in a wider region.

In the above battery casing bottom structure, the second extruded member includes a flange portion protruding toward the first extruded member, and the flange portion is joined with the top face of the first extruded member.

This configuration enables an increase in the positional accuracy in joining the first extruded member and the second extruded member.

The battery casing bottom structure disclosed in the specification includes a combination of two extruded members having different extrusion directions to increase rigidity and also includes an undersurface having a substantially horizontally planar shape to thereby cope with aerodynamics and interference from the road surface.

### BRIEF DESCRIPTION OF DRAWINGS

Embodiments of the present disclosure will be described based on the following figures, wherein:

FIG. 1 is a perspective view schematically illustrating joining of extruded members in a battery casing bottom structure;

FIG. 2 is a cross sectional view of the bottom structure taken along line A-A in FIG. 1;

FIG. 3 is a cross sectional view of a battery casing bottom structure in a modification example;

FIG. 4 is a cross sectional view illustrating a battery casing bottom part having a different configuration from the battery casing bottom structure disclosed in the specification; and

FIG. 5 is a cross sectional view illustrating a battery casing bottom part having a different configuration from the battery casing bottom structure disclosed in the specification.

### DESCRIPTION OF EMBODIMENTS

A battery casing storing a plurality of battery modules (not depicted) as a driving power source is disposed in a lower part of a vehicle. The bottom structure of the battery casing (hereinafter referred to as the “battery casing bottom structure”) will be described by reference to the drawings. In each drawing, signs “Fr”, “Up”, and “Rh” indicate a vehicle forward direction, a vehicle upward direction, and a vehicle rightward direction, respectively.

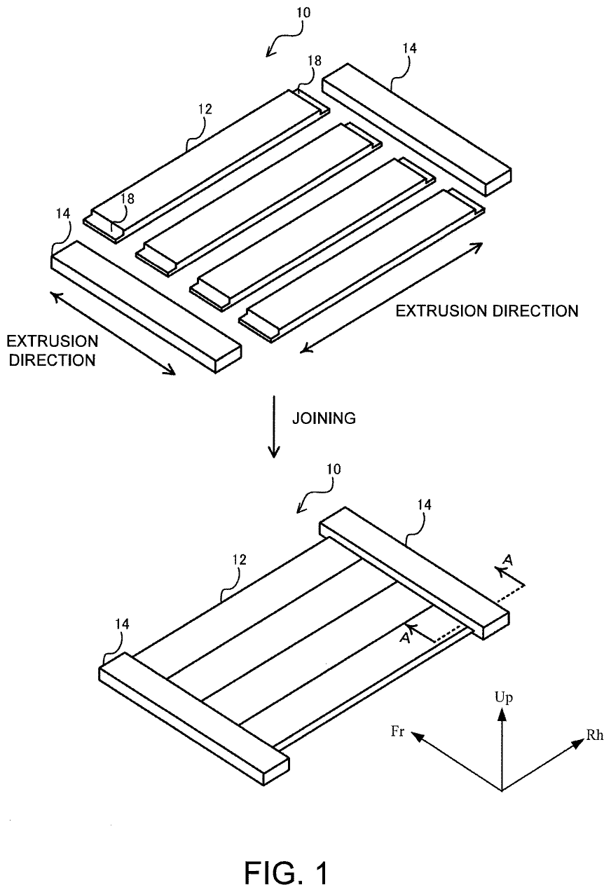

FIG. 1 is a perspective view schematically illustrating joining of extruded members in a battery casing bottom structure. FIG. 1 illustrates, at the top, extruded members before being joined, and illustrates, at the bottom, a bottom part of the battery casing with the extruded member joined together. As illustrated in FIG. 1, a battery casing bottom part 10 includes first extruded members 12 and second extruded members 14. While in FIG. 1, four first extruded members 12 and two second extruded member 14 respectively disposed at opposite ends of the first extruded members 12 are combined to form the battery casing bottom part 10, the numbers of the extruded members are not limited to this example. The first extruded members 12 are arranged such that the direction in which the first extruded members 12 have been extruded by an extruder (not depicted) during molding, which will be hereinafter referred to as the “extrusion direction” as appropriate, is parallel to the vehicle width. Each of the first extruded members 12 includes notches 18 (which reference numeral will be omitted as appropriate) or cut-outs at opposite end portions in the extrusion direction on a top face. The second extruded members 14 are arranged such that the extrusion direction of the second extruded members 14 is parallel to the vehicle length. Therefore, the extrusion direction of the first extruded member 12 and the extrusion direction of the second extruded member 14 are perpendicular to each other. Two types of extruded members having different extrusion directions are combined, as described above, to thereby increase rigidity of the bottom part of the battery casing. Alternatively, the first extruded members 12 may be arranged in parallel to the vehicle length and the second extruded members 14 may be disposed in parallel to the vehicle width.

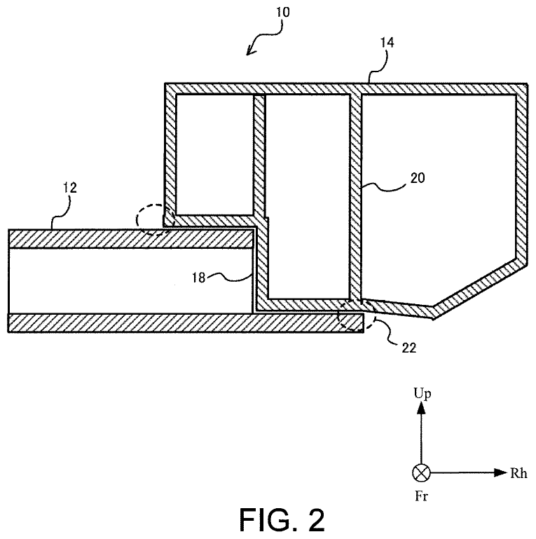

Referring to FIG. 2, the configuration of the bottom part 10 of the battery casing will be described in further detail. FIG. 2 is a cross sectional view of the bottom part 10 taken along line A-A of FIG. 1. The second extruded member 14 is a hollow aluminum member, and includes a rib 20 connecting a top face portion and an undersurface portion in the hollow portion. The hollow shape of the second extruded member 14 decreases the weight of the second extruded member 14. This hollow shape further enables absorption of an input load by deformation, in case of receiving an interference input from under the vehicle, and is therefore advantageous in terms of battery protection. While in the example illustrated in FIG. 2, the first extruded member 12 also has a hollow shape, the shape of the first extruded member 12 is not limited to this example.

As illustrated in FIG. 2, the first extruded member 12 and the second extruded member 14 are joined together by covering the notch 18 of the first extruded member 12 with the undersurface of the second extruded member 14 from above. This joining is performed with arc welding at two locations encircled with broken lines; however, the joining method is not limited to this example. During joining, the rib 20 is placed immediately above a lower joint 22 of the two joining locations. Disposing the rib 20 further increases rigidity of the bottom part 10 of the battery casing. More specifically, while stress is likely to be concentrated in the joints between the first extruded member 12 and the second extruded member 14, the presence of the rib 20 increases rigidity of especially the second extruded member 14. This inhibits deformation of the bottom part 10 of the battery casing against the interference input from under the vehicle, thereby protecting the battery.

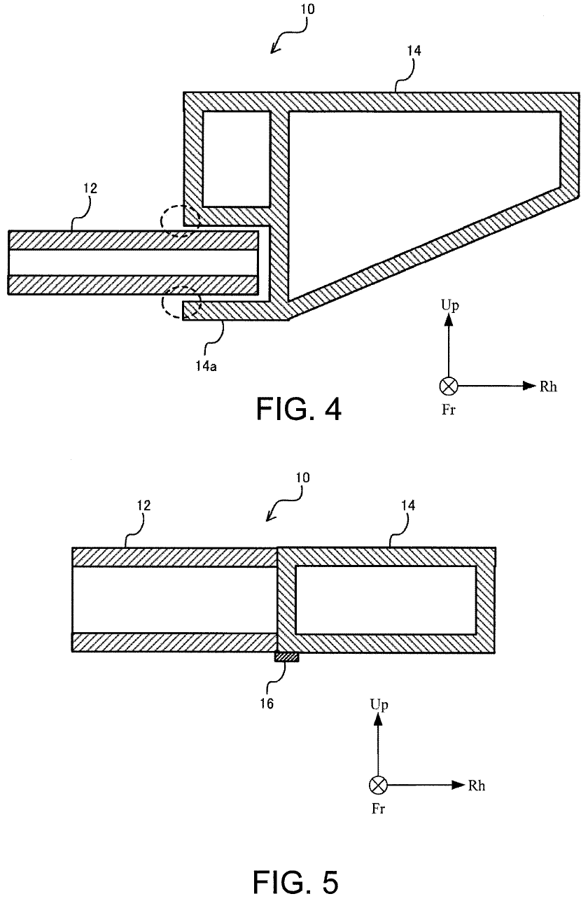

Further, the lowermost surface of the bottom part 10 of the battery casing is the undersurface of the first extruded member 12, as illustrated in FIG. 2. As such, the battery casing bottom structure disclosed in the specification has the lowermost surface having a substantially horizontally planar shape in a wider range as compared to the bottom parts of the battery casings described above by reference to FIGS. 4 and 5.

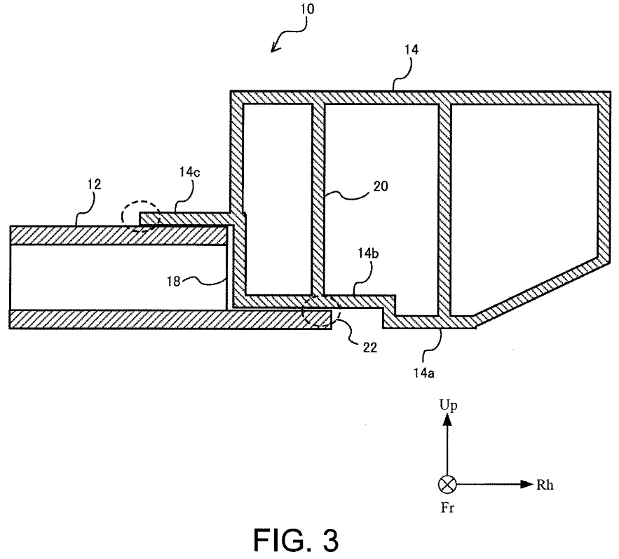

Referring now to FIG. 3, a modification example of a battery casing bottom structure will be described. FIG. 3 is a cross sectional view of the modification example battery casing bottom structure, which has a basic structure similar to that of the bottom structure illustrated in FIG. 2. Specifically, the first extruded member 12 and the second extruded member 14 are joined together by covering the notch 18 of the first extruded member 12 with the undersurface of the second extruded member 14 from above. This joining is performed with arc welding at two locations encircled with broken lines. Similar to the example described above, the joining method is not limited to arc welding.

Meanwhile, the second extruded member 14 of the battery casing bottom part 10 illustrated in FIG. 3 has a shape that differs from the shape of the second extruded member 14 illustrated in FIG. 2. As illustrated in FIG. 3, the second extruded member 14 includes a lower undersurface portion 14a and a higher undersurface portion 14b. The lower undersurface portion 14a forms the lowest part of the second extruded member 14 and is disposed one step below the higher undersurface portion 14b. The higher undersurface portion 14b corresponds to a portion to be joined with the notch 18 of the first extruded member 12; more specifically, a portion to be placed on the notch 18. The undersurface of the second extruded member 14 including two faces having different heights, the lower undersurface portion 14a and the higher undersurface portion 14b, provides a seat surface shape, which further effectively increases rigidity of the battery casing bottom part 10. The undersurface of the second extruded member 14, having a seat surface shape, further enables adjustment of the lower undersurface portion 14a and the undersurface of the first extruded member 12 to have the same height level from the ground. The lower undersurface portion 14a and the undersurface of the first extruded member 12 thus serve as the lowermost surface of the bottom part 10 of the battery casing, which has a substantially horizontally planar shape in a wider range.

The second extruded member 14 illustrated in FIG. 3 further includes a flange portion 14c. The flange portion 14c protrudes toward the first extruded member 12 and is joined with the top face of the first extruded member 12. While the flange portion 14c and the top face of the first extruded member 12 are joined with a removable method, such as with bolt clamping, the flange portion 14c and the top face of the first extruded member 12 may be joined with welding as described above. The flange portion 14c enables higher positional precision in joining the first extruded member 12 and the second extruded member 14.

As described above, the battery casing bottom structure disclosed in the specification has a configuration including the second extruded member 14 disposed on the first extruded member 12. This configuration having the undersurface of the first extruded member 12 as the lowermost surface of the battery casing bottom part 10 can provide a substantially horizontally planar shape in a wide area. This configuration further including the rib 20 immediately above the joint 22 of the first extruded member 12 and the second extruded member 14 enables increased rigidity.

The above description is only illustrative; the battery casing bottom structure disclosed in the specification needs to include the first extruded member 12 having the notch 18 at an end in the extrusion direction on the top face, and the second extruded member 14 having an extrusion direction perpendicular to that of the first extruded member 12 and covering the first extruded member 12 from above for joining such that the rib 20 is located immediately above the joint 22, and may have any modifications in other elements. For example, while in FIG. 2, the undersurface of the first extruded member 12 serves as the lowermost surface of the battery casing bottom part 10, the undersurface of the second extruded member 14 may be sloped to adjust the undersurface of the second extruded member 14 to be level with the undersurface of the first extruded member 12. More specifically, the first extruded member 12 and the second extruded member 14 may be joined such that the undersurfaces of the first and second extruded members 12 and 14 are in a substantially horizontal plane without either one of the undersurfaces protruding further downward. This configuration includes the undersurface of the first extruded member 12 and the undersurface of the second extruded member 14 combined to serve as the lowermost surface of the battery casing bottom part 10 in a wider area.

### REFERENCE SIGN LIST

10 battery casing bottom part, 12 first extruded member, 14 second extruded member, 14a lower undersurface portion, 14b higher undersurface portion, 14c flange portion, 18 notch, 20 rib, 22 joint.

1. A battery casing bottom structure comprising a combination of extruded members, the battery casing bottom structure mounted in a lower part of a vehicle, the battery casing bottom structure comprising:
a first extruded member including a notch that is a cut portion at an end in an extrusion direction of the first extruded member on a top face of the first extruded member;
a second extruded member having a hollow shape, the second extruded member including a rib connecting a top face portion and an undersurface portion, wherein
the first extruded member and the second extruded member are joined to each other by covering the notch of the first extruded member with an undersurface of the second extruded member from above,
the extrusion direction of the first extruded member and an extrusion direction of the second extruded member are perpendicular to each other, and
the rib is positioned immediately above a portion where the first extruded member and the second extruded member are joined.

2. The battery casing bottom structure according to claim 1, wherein
the undersurface of the second extruded member comprises a first portion joined with the notch and a second portion located at a lower level than the first portion in a vertical direction, to thereby provide a seat surface shape, and
the second portion that is a lowermost face of the second extruded member and an undersurface of the first extruded member are disposed to provide a substantially horizontally planar shape.

3. The battery casing bottom structure according to claim 1, wherein
the second extruded member comprises a flange portion protruding toward the first extruded member, and
the flange portion is joined with the top face of the first extruded member.
